(19) United States
(12) Patent Application Publication
(10) Pub. No.: US 2006/0227118 A1
(43) Pub. Date: Oct. 12, 2006

(54) Digital notepad with changeable writing style

(76) Inventor: Tzong-Wei Uen, Miao-Li City (TW)

Correspondence Address: LEONG C LEI, PMB # 1008, 1867 YGNACIO VALLEY ROAD, WALNUT CREEK, CA, 94598, US

(21) Appl. No.: 11/102,803

(22) Filed: Apr. 11, 2005

(51) Int. Cl. G09G 5/00

(52) U.S. Cl. 345/173

(57) ABSTRACT

A digital notepad which records not only the trace but also the style of the trace is provided. The digital notepad provides a set of dedicated writing tools, each of which would issue a predetermined radio signal representing the writing tool's pen color, pen style, and tool type. When a user uses one of the writing tools to write on a piece of paper in a designated area on the digital notepad, the writing tool issues the predetermined radio signal. The digital notepad could recognize the radio signal and store the relevant style information along with the trace data of the writing tool into a memory of the digital notepad, which later could be retrieved and reproduced on a computer.

### BACKGROUND OF THE INVENTION

(a) Technical Field of the Invention

The present invention generally relates to digital notepads, and more specifically to a digital notepad with a set of dedicated writing tools so that the digital notepad is capable of recording not only the trace but also the style of the writing tools.

(b) Description of the Prior Art

Digital notepads have gained wide spread popularity recently due to their mobility, convenience, memorizing capability, and the conformance to people's writing habit.

These digital notepads usually provide a special stylus for writing on the digital notepad or on a piece of paper. However, when the trace of the stylus is stored in the digital notepad and later uploaded to a computer, the prevailing digital notepads only support a single style of trace. That is, there is only one pen color and only one trace width. A user has to modify the trace manually on the computer using an editing application program to adjust the trace's style (such as color, width, etc.). This is, of course, a time consuming effort and requires a degree of familiarity with the editing application program, which all together poses a significant constraint on the usability of digital notepads.

What is yet to be available in these conventional digital notepads is the capability to recognize the styles of the stylus when recording its trace. If the style information could be saved along with the trace data, and a drawing could be reproduced identically on the computer to what is originally written on the digital notepad, the digital notepad would become an even more user-friendly input device for computer laymen.

### SUMMARY OF THE INVENTION

The primary purpose of the present invention is to provide a digital notepad that could obviate the foregoing shortcomings of the conventional ones. The digital notepad of the present invention provides a set of dedicated writing tools (including various stylus and other type of tools such as eraser and compass) along with it. Each of the writing tools would issue an unique and predetermined radio signal representing the writing tool's pen color, pen style (such as its trace width), and tool type (such as a pen, a compass, an eraser, etc.)

When a user uses one of the writing tools to write on a piece of paper in a designated area on the digital notepad, the pressure exerted on the tool's tip would cause the writing tool to issue the pre-determined radio signal. The digital notepad could receive and decipher the radio signal and store the relevant style information along with the trace data of the writing tool into a memory of the digital notepad. Therefore, a user could constantly change the writing tool used to write on a same piece of paper. When the trace data is uploaded later into a computer, an identical handwriting drawing could be reproduced on the computer's screen automatically, without further manual modification. During the writing, the style of the writing tool currently used is shown in a status display on the digital notepad of the present invention so that the user could know exactly the style of the trace he or she is generating.

The foregoing object and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a schematic diagram showing a digital notepad according to an embodiment of the present invention.

FIG. 2 is a flow chart showing the working process of a digital notepad according to an embodiment of the present invention.

FIG. 3 is a flow chart showing the working process of a computer retrieving the data stored in a digital notepad according an embodiment of the present invention.

FIG. 4 is a schematic diagram showing the signal reception circuit of a digital notepad according to an embodiment of the present invention.

FIG. 5 is a schematic diagram showing the signal transmission circuit of a writing tool according to an embodiment of the present invention.

### DETAILED DESCRIPTION OF THE PREFERRED EMBODIMENTS

The following descriptions are of exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

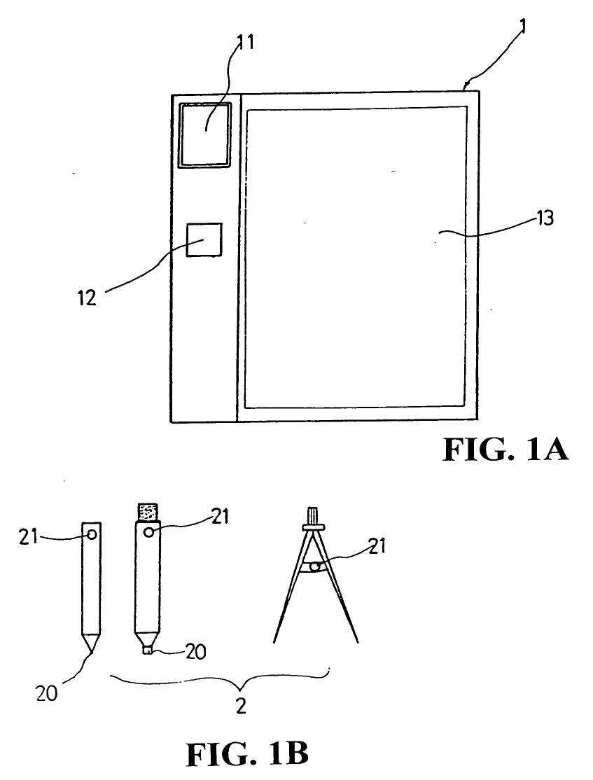

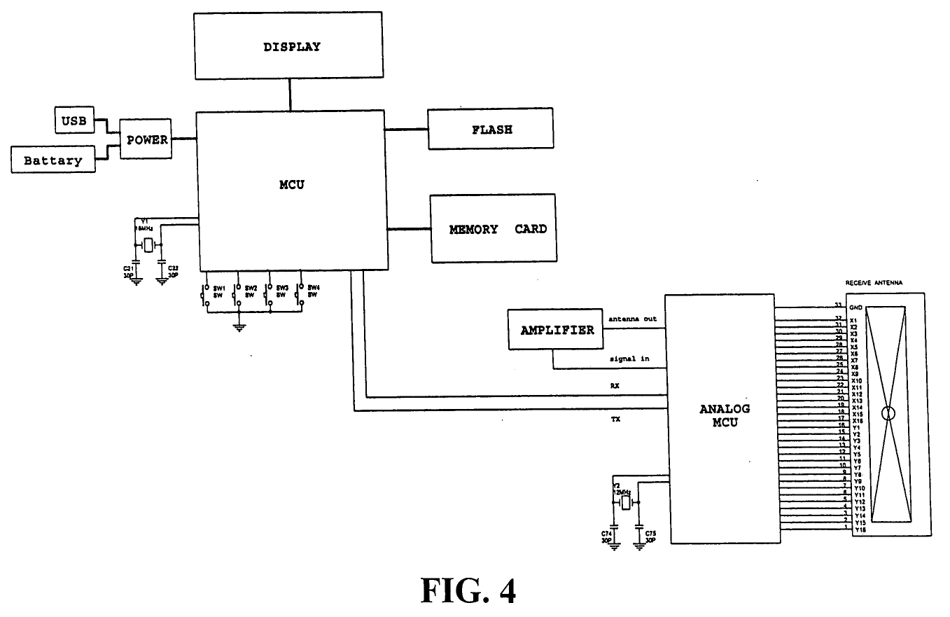

FIG. 1 is a schematic diagram showing a digital notepad according to an embodiment of the present invention. As illustrated, the digital notepad 1 contains a status display 11, a number of control buttons 12, and a writing area 13. The status display 11 provides information about the style of the writing tool 2, such as the pen color, pen type, tool type, etc., currently in use. These information may be presented in the status display using various icons, text, and symbols, and with various colors. Inside the digital notepad 1, there is a signal reception circuit as depicted in FIG. 4, which receives and deciphers the radio signals issued from the writing tools 2. The signal reception circuit of the digital notepad 1 is able to sense the handwriting trace written on a paper in the writing area 13, along with the style of the writing tools 2 used, and stores these data in a memory in the signal reception circuit. The digital notepad 1 also contains a memory management device for managing the data stored in the memory.

An application program inside the digital notepad 1 contains a recognition kernel that can recognize the data stored in the memory. The result of recognition can then be converted into various graphic or other types of formats by a conversion subprogram of the application program. The application program also contains another conversion subprogram that could convert the recognized data into various types of file formats.

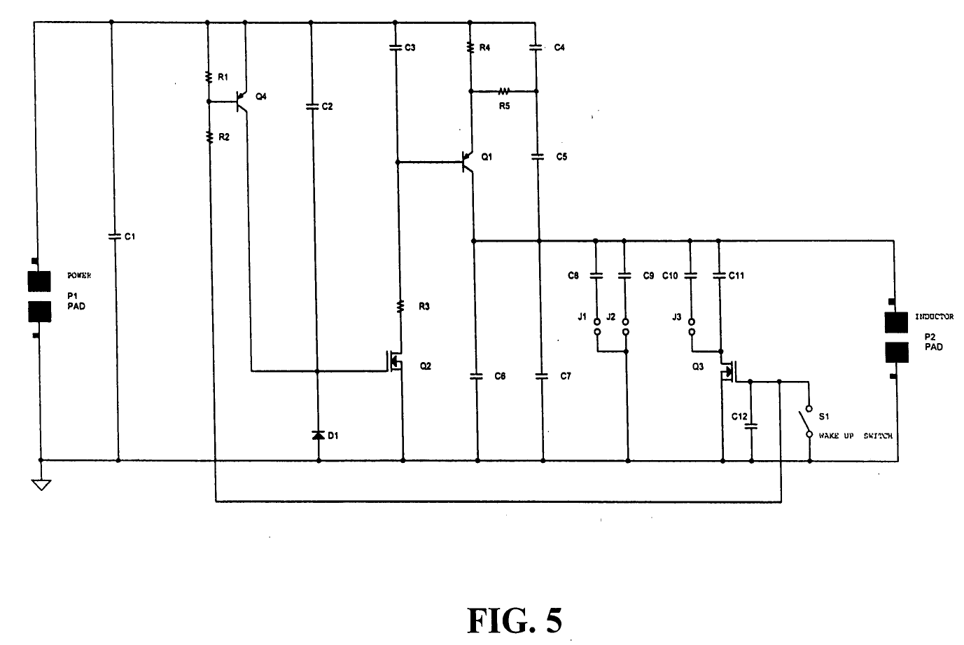

With reference to FIG. 1 again, the digital notepad 1 has a set of dedicated writing tools 2. Each of the writing tools 2 has a signal transmission circuit 21 as illustrated in FIG. 5. With the unique and pre-determined radio signal issued from the signal transmission circuit 21, the digital notepad 1 is able to know the exact style of the writing tool 2 currently in use and display the relevant information in the status display. Each of the writing tools 2 has a replaceable cartridge 20 usually with the corresponding style as designated by the radio signal issued from the writing tool 2's signal transmission circuit. Please note that different writing tools would issue different radio signals. The definition of a writing tool 2's issued radio signal could be changed by a user as required. In other words, a writing tool 2 with a black-colored cartridge 20 could issue a signal deciphered by the digital notepad 1 as red color. The cartridge 20 usually allows it to be directly used to write on a normal piece of paper in the writing area 13, just like people usually write on a normal piece of paper.

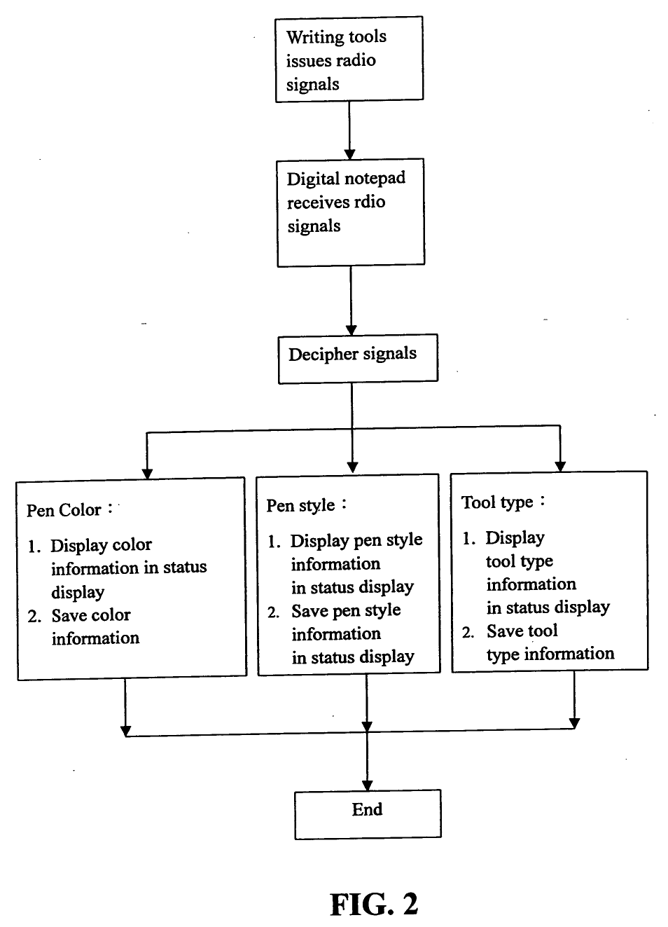

FIG. 2 is a flow chart showing the working process of a digital notepad according to an embodiment of the present invention. First, the writing tool 2 used issues a radio signal to the digital notepad 1. The digital notepad 1 receives the radio signal and deciphers the radio signal to learn the pen color, pen type, and tool type of the writing tool 2. The digital notepad 1 then records and shows the style information in the status display 11.

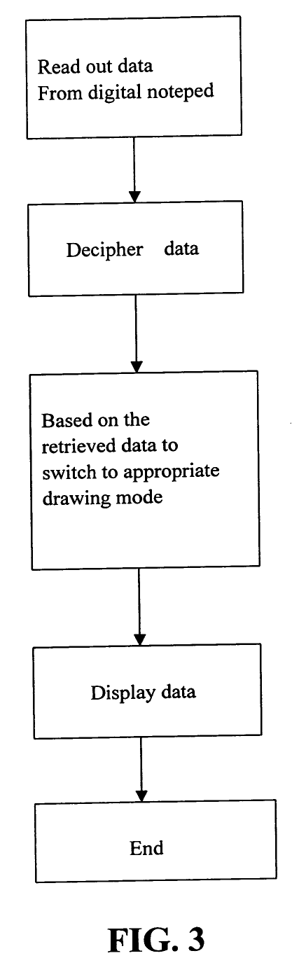

FIG. 3 is a flow chart showing the working process of a computer retrieving the data stored in a digital notepad according an embodiment of the present invention. The digital notepad 1 of the present embodiment has a universal serial bus (USB) interface that could be used to connect to a computer having a corresponding interface. An application program running on the computer is able to retrieve data saved in the digital notepad 1's memory. When the application program reads out the data, it first deciphers the data and then displays the data on a screen of the computer. During the process, the application would based on the data about the pen color, pen style and tool style to regenerate the traces (text, graphics, or symbols) written down by a user on the digital notepad 1.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A digital notepad system comprising:
at least a writing tool which comprises a signal transmission circuit issuing an unique and pre-determined radio signal to a digital notepad of said digital notepad system;
a digital notepad comprising:
a signal reception circuit which receives and deciphers said radio signal of said writing tool into a style information about the pen color, pen style, and tool type of said writing tool;
a memory for storing a trace data along with said style information of said writing tool;
a memory management device for managing said trace data along with said style information stored in said memory; and
a status display for showing said style information of said writing tool; and
an application program comprising:
a recognition kernel for recognizing said trace data along with said style information stored in said memory;
a first conversion subprogram for converting a recognized data by said recognition kernel into various graphic formats; and
a second conversion subprogram for converting said recognized data by said recognition kernel into various file formats.

2. The digital notepad system according to claim 1, wherein said style information is displayed in said status display using at least one of the following means: icons, text, and symbols, and with various colors.

3. The digital notepad system according to claim 1, wherein said writing tool has a replaceable cartridge, said cartridge has a specific pen color and pen style, and said cartridge allows said writing tool to write on a normal piece of paper in a specific area of said digital notepad.

4. The digital notepad system according to claim 1, wherein the definition of said radio signals of said writing tools is modifiable.
